(19) United States
(12) Patent Application Publication
(10) Pub. No.: US 2006/0056506 A1
(43) Pub. Date: Mar. 16, 2006

(54) System and method for embedding multimedia compression information in a multimedia bitstream

(76) Inventors: Chia Chiang Ho, Taipei (TW); Ho Chao Huang, Shindian City (TW); Jau Hsiung Huang, Shindian City (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(21) Appl. No.: 10/939,542

(22) Filed: Sep. 13, 2004

(51) Int. Cl. H04N 11/04; H04N 5/14; H04N 11/02; H04N 9/64; H04N 7/12; H04B 1/66

(52) U.S. Cl. 375/240.01; 348/700

(57) ABSTRACT

Systems and methods for embedding multimedia compression information in a multimedia bitstream to form a hybrid multimedia bitstream having data representing multimedia compression information as well data representing a multimedia signal. The embedded multimedia compression information may be extracted from the multimedia bitstream by an executable module to assist in processing, playing, or editing the multimedia bitstream.

### TECHNICAL FIELD

The present invention relates to systems and methods for processing multimedia bitstreams and, more specifically, relates to systems and methods for embedding multimedia compression information in, and extracting multimedia compression information from, a multimedia bitstream.

### BACKGROUND OF THE INVENTION

The need to analyze, edit, and process digital multimedia content, for example, digital audio or digital video, has become a necessity for those who manipulate multimedia content. Processing and editing multimedia content, at one time, was thought of as a task only performed by professional studios. However, advances in computing hardware and the technology used for editing audio and video has opened the door to non-professionals as well.

For example, a home movie may be recorded using a personal camcorder and transferred to a personal computer for processing, editing, or long-term storage. Digital camcorders, for example, record audio, video, and other information related to the home movie in digital form, such as on tape, computer memory, or a mass storage medium. The home movie may then be transferred to a personal computer using any number of interfaces, and then stored as a digital stream such as multimedia file in a number of common formats such as MPEG-1, MPEG-2, or DV, for example.

Due to algorithm complexity and the relatively large amounts of multimedia data that is typically edited and/or processed, the task of analyzing, processing, and editing multimedia content can take a considerable amount of time, even on powerful computers.

One example of multimedia processing that may be performed is the compression of multimedia. For example, a video shot using a home camcorder in the DV format typically contains video information representing the video signal, and may also contain audio information corresponding to the video. However, a multimedia bitstream in the high-quality DV format may be inconveniently large for manipulation and storage. To resolve this inconvenience, the DV bitstream may be converted into the MPEG-2 format, for example. This conversion requires compression of the DV multimedia content, which ultimately produces a smaller, compressed bitstream.

To compress the multimedia content, the multimedia content may be analyzed using a variety of algorithms, which may be computationally complex and time consuming. The analysis may, typically after a considerable amount of time, provide information needed for multimedia compression. Accordingly, multimedia manipulation software (e.g. software video compression) may use this information to perform the compression.

This analysis is typically completed in a vacuum, without the consideration of possible prior processing or analysis that may have been performed on the same multimedia content. Additionally, if later the multimedia bitstream is needed to be analyzed for other purposes, such as in preparation for detecting scene changes in the multimedia bitstream, the analysis is performed without regard to the prior compression analysis. This may be true even though the same type of analysis (e.g. motion detection, etc.) was performed previously when determining the compression information.

Additionally, if the multimedia bitstream is passed to another user or analyzed using different software, as is common, the information from any prior analysis is lost. Thus, any analysis of the multimedia bitstream already performed is repeated. This repeated reanalysis of the multimedia bitstream can be very time consuming and wasteful of computing and personnel resources.

### SUMMARY

The present invention is directed to systems and methods for embedding multimedia compression information in, and extracting multimedia compression information from, a multimedia bitstream.

One embodiment of the present invention is directed to a method for processing a multimedia bitstream. The method comprises: analyzing a multimedia bitstream for characteristics of a multimedia signal useful for compressing multimedia content within the multimedia bitstream; generating multimedia compression information based on the characteristics of the multimedia signal useful for compressing the multimedia content; and embedding the multimedia compression information into the multimedia bitstream to produce a hybrid multimedia data stream.

Another embodiment of the present invention is directed to a method for processing a multimedia bitstream. The method includes embedding multimedia compression information within a multimedia bitstream, the multimedia compression information signifying characteristics of a multimedia signal useful for compressing multimedia content within the multimedia bitstream.

Another embodiment is directed to a computer readable medium having a computer program for processing a multimedia bitstream. The computer readable medium includes a code segment for embedding multimedia compression information within a multimedia bitstream, the multimedia compression information signifying characteristics of a multimedia signal useful for compressing multimedia content within the multimedia bitstream.

Yet another embodiment is directed to a system for processing a multimedia bitstream. This system includes an executable module for embedding multimedia compression information within a multimedia bitstream. The multimedia compression information signifies characteristics of a multimedia signal useful for compressing multimedia content within the multimedia bitstream.

Yet another embodiment is directed to a system for processing a multimedia bitstream. The system includes an executable module for extracting information determined from a prior analysis of the multimedia bitstream from the multimedia bitstream. The system also includes an executable module for determining multimedia compression information by using the extracted information from the prior analysis. Additionally, an executable module is included for embedding the multimedia compression information in the multimedia bitstream.

Other systems, methods, features and/or advantages will be or may become apparent to one with skill in the art upon examination of the following drawings and detailed description. It is intended that all such additional systems, methods, features and/or advantages be included within this description and be protected by the accompanying claims.

### BRIEF DESCRIPTION OF THE DRAWINGS

The components in the drawings are not necessarily to scale relative to each other. Like reference numerals designate corresponding parts throughout the several views.

FIG. 1 depicts an exemplary system for embedding multimedia compression information in, and extracting multimedia compression information from, a multimedia bitstream.

FIG. 2 depicts a block diagram of the exemplary computer system of FIG. 1, which includes executable modules for embedding multimedia compression information in, and extracting multimedia compression information from, a multimedia bitstream.

FIG. 3 depicts a block diagram of an embodiment of a system for determining the multimedia compression information to be embedded within a multimedia bitstream.

FIG. 4 depicts an exemplary system for embedding multimedia compression information within a multimedia bitstream.

FIG. 5 depicts a block diagram of an exemplary embodiment of a system for extracting multimedia compression information from a multimedia bitstream, and for embedding multimedia compression information in a multimedia bitstream.

FIG. 6 depicts an exemplary method for embedding multimedia compression information in a multimedia bitstream.

FIG. 7 depicts yet another exemplary method for multimedia compression information in, and extracting multimedia compression information from, a multimedia bitstream.

### DETAILED DESCRIPTION

Embodiments of systems and methods for embedding multimedia compression information in, and extracting multimedia compression information from, a multimedia bitstream are described. Multimedia compression information generally refers to information that may be used by an executable module to compress a multimedia bitstream. For example, a multimedia bitstream having audio and/or video content may be analyzed by any number of algorithms which provide information which a compression algorithm may use to compress the multimedia. In some embodiments a user may supply the multimedia compression information through a user interface or file.

A multimedia bitstream may be, for example, any number of types of files, data streams, or digital broadcasts representing any combination of audio, video, data, text, pictures, etc. For example, multimedia streams may take the format of an MPEG-1 bitstream, an MPEG-2 bitstream, an MPEG-4 bitstream, an H.264 bitstream, a 3GPP bitstream, a 3GPP-2 bitstream, Standard-Definition Video (SD-Video) bitstream, a High-Definition Video (HD-Video) bitstream, a Digital Versatile Disc (DVD) multimedia bitstream, a Video Compact Disc (VCD) multimedia bitstream, a High-Definition Digital Versatile Disc (HD-DVD) multimedia bitstream, a Digital Television Video/High-definition Digital Television (DTV/HDTV) multimedia bitstream, an AVI bitstream, a digital video (DV) bitstream, a QuickTime (QT) file, Windows Media Audio (WMA) bitstream, a Windows Media Video (WMV) bitstream, an Advanced System Format (ASF) bitstream, or any number of other popular digital multimedia formats. The above exemplary data streams are merely examples, and it is intended that the system cover any type of multimedia bitstream in its broadest sense.

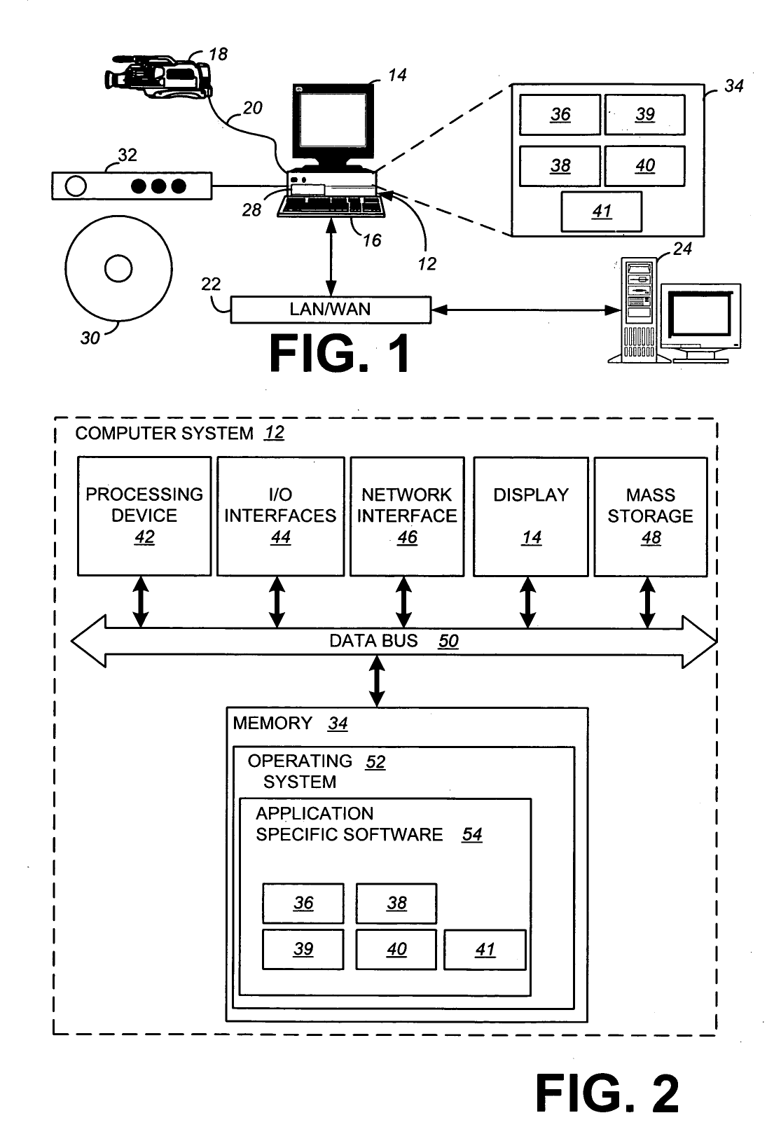

In accordance with certain aspects of a multimedia processing system, FIG. 1 depicts a system for embedding multimedia compression information in, and extracting multimedia compression information from, a multimedia bitstream. The system includes a computer system 12 having a display 14 and user input device 16, which may be a keyboard or a mouse, for example.

A video camera 18 may be coupled to computer system 12 via an electrical cable 20 or a wireless connection. Video camera 18 may, for example, be a digital camcorder which records multimedia content in a variety of digital formats. In this embodiment, electrical cable 20 may be any number of common computer interface cables, such as, but not limited to IEEE-1394 High Performance Serial Bus (Firewire), Universal Serial Bus (USB), a serial connection, or a parallel connection. In this embodiment, a digital multimedia stream may be transferred from video camera 18 to computer system 12 over electrical cable 20.

Computer system 12 may also form a node on a network 22 such as, but not limited to, a LAN or a WAN. In this configuration, multimedia bitstreams may be delivered from a remote server 24 over network 22 to computer system 12. The connection between the remote server 24 and computer system 12 may be any number of standard networking interfaces such as a CAT-5, Firewire, or wireless connection. Computer system 12 may also include optical drive 28 to receive and read optical disk 30, which may have multimedia bitstreams encoded thereon.

In some embodiments, a multimedia bitstream may be downloaded to the computer system 12 using multimedia input device 32 which may be a break-out box, or could be integrated onto an expansion card, either of which are electrically connected to computer system 12.

Multimedia input device 32 may include a variety of standard digital or analog input connections for receiving multimedia signals such as, but not limited to, RCA jacks, a microphone jack, Sony/Philips Digital Interface (S/PDIF) connections, optical connections, coaxial cable, and S-video connections. Multimedia input device 32 may include an analog-to-digital converter for converting analog multimedia to digital multimedia streams. In an embodiment in which multimedia input device 32 is a break-out box external to computer system 12, the box is electrically connected in an number of ways, for example, but not limited to, Firewire, USB, a serial connection, or a parallel connection.

Computer system 12 includes a memory 34, which may be used to store a number of executable modules therein. In some embodiments, any of a multimedia acquisition module 36, multimedia analyzing module 38, multimedia playback module 39, multimedia editing module 40, and multimedia processing module 41 may be stored therein. Memory 34 may include a number of other modules which, for example, could be sub-modules of multimedia acquisition module 36, multimedia analyzing module 38, multimedia playback module 39, multimedia editing module 40, and multimedia processing module 41.

In general, multimedia acquisition module 36 functions to acquire a multimedia bitstream. Multimedia acquisition module 36 may acquire a multimedia bitstream in a number of ways, depending on the source. For example, multimedia acquisition module 36 may coordinate the transfer of a multimedia bitstream from video camera 18, optical disc 28, remote server 24, or a mass storage device 48 (FIG. 2) to computer system 12. Multimedia acquisition module 36 also provides the multimedia bitstream to executable modules such as multimedia analyzing module 38, multimedia playback module 39, multimedia editing module 40, and multimedia processing module 41.

Multimedia analyzing module 38 performs the function of analyzing the audio and video content within a multimedia bitstream to determine information used for multimedia compression. Multimedia editing module 40 may perform a number of multimedia editing tasks which may be based on the information used for multimedia compression. Similarly, multimedia processing module 41 may perform multimedia processing tasks on the multimedia bitstream which may be based on the information used for multimedia compression. Accordingly, multimedia playback module 39, multimedia editing module 40, and multimedia processing module 41 may manipulate the multimedia bitstream based on multimedia compression information supplied by multimedia analyzing module 38.

In some embodiments, multimedia acquisition module 36, multimedia analyzing module 38, multimedia playback module 39, multimedia editing module 40, and multimedia processing module 41 may be combined into a single module that performs any combination of the tasks performed by each of the modules separately. Thus, any modules or submodules described herein are not limited to existing as separate modules. In reality all modules may operate apart from one another, or could easily be combined as one module. Additionally, it should be understood that each and every module is not essential to perform the systems and methods described herein.

In some embodiments, a user may interact and control the operation of any of multimedia acquisition module 36, multimedia analyzing module 38, multimedia playback module 39, multimedia editing module 40, and multimedia processing module 41 through user input device 16 and a graphical user interface within display 14.

Each of the executable modules, such as multimedia acquisition module 36, multimedia analyzing module 38, multimedia playback module 39, multimedia editing module 40, multimedia processing module 41, and any sub-modules may comprise an ordered listing of executable instructions for implementing logical functions. When the executable modules are implemented in software, it should be noted that the system can be stored on any computer-readable medium for use by, or in connection with, any computer-related system or method. In the context of this document, a computer-readable medium is an electronic, magnetic, optical, or other physical device or apparatus that can contain or store a computer program for use by or in connection with a computer-related system or method. The executable modules can be embodied in any computer-readable medium for use by, or in connection with, an instruction execution system, apparatus, or device, such as a computer-based system, processor-containing system, or other system that can fetch the instructions from the instruction execution system, apparatus, or device and execute the instructions.

In the context of this document, a “computer-readable medium” can be essentially anything that can store, communicate, propagate, or transport the program for use by or in connection with the instruction execution system, apparatus, or device. The computer readable medium can be, for example, but not limited to, an electronic, magnetic, optical, electromagnetic, infrared, or semiconductor system, apparatus, device, or propagation medium. More specific examples (a nonexhaustive list) of the computer-readable medium would include the following: an electrical connection (electronic) having one or more wires, a portable computer diskette (magnetic), a random access memory (RAM) (electronic), a read-only memory (ROM) (electronic), an erasable programmable read-only memory (EPROM, EEPROM, or Flash memory) (electronic), an optical fiber (optical), and a portable compact disc read-only memory (CDROM) (optical). Note that the computer-readable medium could even be paper or another suitable medium upon which the program is printed, as the program can be electronically captured, via optical scanning of the paper or other medium, then compiled, interpreted or otherwise processed in a suitable manner if necessary, and then stored in a computer memory.

FIG. 2 is a block diagram illustrating an exemplary embodiment of computer system 12 on which multimedia acquisition module 36, multimedia analyzing module 38, multimedia playback module 39, multimedia editing module 40, and multimedia processing module 41 may be executed. Generally speaking, the computer system 12 can comprise any one of a wide variety of wired and/or wireless computing devices, such as a desktop computer, portable computer, dedicated server computer, multiprocessor computing device, cellular telephone, personal digital assistant (PDA), handheld or pen based computer, embedded appliance and so forth. Irrespective of its specific arrangement, computer system 12 can, for instance, comprise memory 34, a processing device 42, a number of input/output interfaces 44, a network interface device 46, and mass storage 48, wherein each of these devices are connected across a data bus 50.

Processing device 42 can include any custom made or commercially available processor, a central processing unit (CPU) or an auxiliary processor among several processors associated with the computer system 12, a semiconductor based microprocessor (in the form of a microchip), a macroprocessor, one or more application specific integrated circuits (ASICs), a plurality of suitably configured digital logic gates, and other well known electrical configurations comprising discrete elements both individually and in various combinations to coordinate the overall operation of the computing system.

The memory 34 can include any one of a combination of volatile memory elements (e.g., random-access memory (RAM, such as DRAM, and SRAM, etc.)) and nonvolatile memory elements (e.g., ROM, hard drive, tape, CDROM, etc.). The memory 34 typically comprises a native operating system 52, one or more native applications, emulation systems, or emulated applications for any of a variety of operating systems and/or emulated hardware platforms, emulated operating systems, etc. For example, the applications may include application specific software 54, which may include any of the multimedia acquisition module 36, multimedia analyzing module 38, multimedia playback module 39, multimedia editing module 40, and multimedia processing module 41. One of ordinary skill in the art will appreciate that memory 34 can, and typically will, comprise other components which have been omitted for purposes of brevity.

Input/output interfaces 44 provide any number of interfaces for the input and output of data. For example, where the computer system 12 comprises a personal computer, these components may interface with user input device 16, which may be a keyboard or a mouse. Where the computer system 12 comprises a handheld device (e.g., PDA, mobile telephone), these components may interface with function keys or buttons, a touch sensitive screen, a stylist, etc. Display 14 can comprise a computer monitor or a plasma screen for a PC or a liquid crystal display (LCD) on a hand held device, for example.

With further reference to FIG. 2, network interface device 46 comprises various components used to transmit and/or receive data over network 22. By way of example, the network interface device 46 may include a device that can communicate with both inputs and outputs, for instance, a modulator/demodulator (e.g., a modem), wireless (e.g., radio frequency (RF)) transceiver, a telephonic interface, a bridge, a router, network card, etc.)

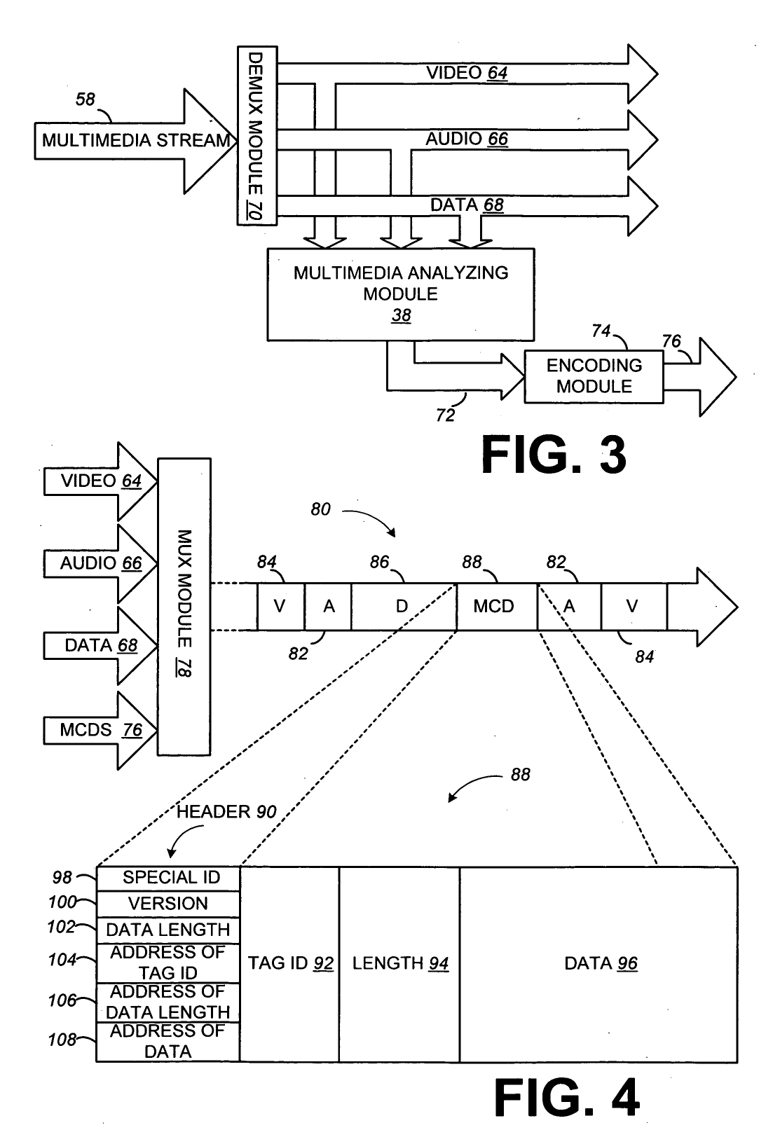

Referring to FIG. 3, an embodiment of a system for determining multimedia compression information to be embedded within a multimedia bitstream is described. In one embodiment, multimedia analyzing module 38 accepts the whole or part of a multimedia bitstream 58 as input and analyzes the multimedia bitstream 58 to determine characteristics of the multimedia stream useful to compress the multimedia bitstream. The analysis may be based upon either, or both of, the audio and video content within the multimedia bitstream 58.

For example, the type of analysis may include, but are not limited to, any of detecting the motion type (zoom, pan, etc.), the motion range, or the motion velocity in the video; detecting direct or transitional scene changes and their types in the video; detecting facial areas in video; detecting the spatial and temporal complexity of the video; detecting perceptual important spatial or temporal regions; and detecting commercial content in the video. The various analyses listed above are merely examples of those which may be performed to provide multimedia compression information in multimedia bitstreams in an automated fashion, and the embodiments of the systems and methods for embedding multimedia compression information into a multimedia bitstream are not limited to the particular type of analysis used.

Each of the analyses used may provide multimedia compression information which indicates characteristics of the multimedia bitstream useful for an executable module to use for compressing the bitstream. For example, characteristics may include, but are not limited to, any of the motion type, the range or velocity of a spatial or temporal portion in the video; the location of a scene change or the location of commercial content in the video; the absolute or relative complexity or importance value of one spatial or temporal portion in the video; the spatial or temporal location of a facial region in the video, or a sound level at a particular position or portion of the audio associated with the video. The multimedia compression information may be embodied in a variety of formats and the systems and methods herein are not limited to any particular format or representation.

While embodiments have been described in which multimedia analyzing module 38 analyzes the bitstream to determine information useful for multimedia compression using automated algorithms, in some embodiments the multimedia compression information may be supplied by the content provider or a viewer of the multimedia content. For example, an executable module such as multimedia analyzing module 38 or multimedia playback module 39 may be configured to provide a graphical user interface within display 14 (FIG. 1) to a viewer of the video content. Through the graphical user interface, the user may indicate (e.g. via a mouse, keyboard, or remote control) particular starting and ending positions in the video content that correspond to commercial content, high degrees of action, or other indicators which may be used by an executable module performing compression. In some embodiments, the multimedia compression information may already be embedded in the multimedia bitstream or supplied in a separate file, signal, or bitstream, for example. This information may be decoded or extracted for use by executable modules just as if the multimedia compression information was determined by analysis of the bitstream.

Some embodiments may use a combination of automatic detection and manual indication of the multimedia compression information. For example, following the example above, multimedia analyzing module 38 may analyze the video content and make a best-guess as to the location of commercial content, high degrees of action, or other indicators which may be used by an executable module performing compression. This best-guess may then be formatted into a human readable format and displayed in the GUI for manual verification and adjustment by the user. This multimedia compression information may then be fed to an executable module. Accordingly, while multimedia compression information may be acquired in any number of methods, of which only a few have been provided as examples, the described systems and methods for embedding multimedia compression information in, and extracting multimedia compression information from, a multimedia bitstream are not limited to any particular method.

Once the multimedia compression information is determined, the information may be used by an executable module, such as multimedia processing module 41, to compress the multimedia content, thereby compressing the bitstream. However, while the information was determined specifically for use by an executable module performing compression, it should be understood that this information may be used for any number of multimedia manipulation tasks. Multimedia analyzing module 38, or other executable modules, may also be configured to embed this multimedia compression information into the multimedia bitstream.

Information, such as closed captioning and title information, are sometimes embedded within multimedia bitstreams in a variety of ways, depending on the particular format of the multimedia bitstream. It is contemplated that the multimedia compression information may be embedded in similar ways, and the systems and methods for embedding the multimedia compression information will vary depending on the format of the multimedia file.

The exemplary embodiment of FIG. 3 depicts a multimedia stream 58 in the MPEG-2 format, for example. The MPEG standard, known as ISO-13818-1, is capable of multiplexing multiple streams of multimedia content into a single stream. For example, each of a video stream 64, audio stream 66, and private data stream 68, may coexist within multimedia stream 58.

Video stream 64, audio stream 66, and private data stream 68 are known as “elementary streams.” The MPEG standard allows for the combination of multiple elementary video, audio, or data streams into the same multimedia stream 58. Thus, for example, multimedia stream 58 may include an audio stream for the English language and a second audio stream for the Spanish language. Likewise, multiple video streams may be used. For example, a first video stream could represent video from one camera angle and a second video stream represents video from another angle. Private data stream 68, sometimes known simply as a data stream, is not limited to any single type of data. Data stream 68 may be used, for example, to provide an identification of multimedia stream 58 or may contain data to be decoded by a closed captioning device.

Multimedia analyzing module 38 may consider each of the audio, video, and data streams separately. Therefore, a demultiplexing system, herein DEMUX 70, may be provided to demultiplex, or separate, the elementary streams from multimedia stream 58. Here, multimedia stream 58 is passed into DEMUX 70 and video stream 64, audio stream 66, and private data stream 68 are provided as inputs to multimedia analyzing module 38.

Multimedia analyzing module 38 may analyze the multimedia bitstream to determine multimedia compression information. For example, the video and/or audio content in the bitstream may be analyzed to determine the multimedia compression information, as described in detail above. In addition to analyzing one, or both, of the audio and video streams, multimedia analyzing module 38 may read and analyze private data stream 68 to determine the multimedia compression information. For example, if data bitstream 68 includes closed captioning text, this text may be analyzed to determine the multimedia compression information.

Additionally, multimedia analyzing module 38 may determine if multimedia compression information has been previously embedded within any of the audio, video, or data bitstreams (e.g. within private data stream 68, for example). For example, if multimedia compression information has been previously embedded, multimedia analyzing module 38 may be configured to skip completely, or substantially reduce, further analysis of the multimedia bitstream by extracting the multimedia compression information directly.

Multimedia analyzing module 38 may also include error checking features, such as using a checksum or other identifying information, to determine if information embedded within the data stream corresponds to a particular version, is reliable information, and/or contains valid multimedia compression information.

Once multimedia analyzing module 38 has analyzed multimedia stream 58, multimedia analyzing module 38 may provide multimedia compression data 72 as its output. In the present embodiment, multimedia compression data 72 represents the multimedia compression information determined from analyzing the audio, video, and/or data bitstreams. Multimedia compression data 72 may be represented in a predetermined format, which may be used directly by other modules such as multimedia playback module 39, multimedia editing module 40, or multimedia processing module 41.

As depicted in FIG. 3, however, multimedia compression data 72 may also be passed through an encoding module 74 to convert the format of multimedia compression data 72 into a bitstream conforming to a variety of standard formats. In other embodiments, encoding module 74 may be integrated within multimedia analyzing module 38, rather than operating as a separate, stand-alone module.

In many cases, it is desirable for encoding module 74 to transform multimedia compression data 72 into a formatted data stream conforming to that required by a particular multimedia standard (e.g. MPEG-2, AVI, etc.). In the present embodiment, the predetermined format of multimedia compression data 72 is not one recognized as conforming to an MPEG-2 bitstream. Thus, encoding module 74 is used to convert the multimedia compression data 72 into an MPEG compliant elementary stream, such as formatted multimedia compression data stream 76 which may be a packetized elementary stream consisting of packetized elementary stream (PES) packets. Accordingly, the multimedia compression information, represented by multimedia compression data 72, is formatted into multimedia compression data stream 76.

FIG. 4 depicts an exemplary system for combining, or multiplexing, the multimedia compression data stream 76 into a hybrid multimedia stream. A multiplexing module, herein MUX 78, accepts inputs of video stream 64, audio stream 66, private data stream 68 as well as the formatted multimedia compression data stream 76 as output by encoding module 74 in FIG. 3. MUX 78 operates to multiplex, encode, or otherwise combine streams 64, 66, 68, and 76 into a single hybrid multimedia stream 80.

Hybrid multimedia stream 80 may then be stored as a file on any type of mass storage system such as a hard drive, floppy drive, optical drive, optical media, tape, etc. Alternatively, the file may be transmitted across a network to a remote host having a module configured to manipulate hybrid multimedia stream 80. For example, multimedia processing module 41, located within computer system 12, may be enabled to read hybrid multimedia stream 80 from the attached mass storage 48.

While the embodiment of FIG. 4 depicts data streams 68 and 76 as separate data streams, in some embodiments, the data within data streams 68 and 76 may be encoded into a single stream. For example, MUX 78, or other circuitry or software upstream of MUX 78, may combine private data stream 68 and formatted multimedia compression data stream 76 into a single data stream. Therefore, for example, title information data, closed captioning data, and multimedia compression data may coexist within the same elementary stream. Additionally, while the embodiment of FIG. 4 is depicted as existing separately, the system may be included as part of another executable module, such as, but not limited to, multimedia analyzing module 38, playback module 39, multimedia editing module 40, or multimedia processing module 41.

As defined herein, hybrid multimedia stream 80 includes data representing a multimedia signal as well as data representing multimedia compression information. A multimedia signal includes a video signal and/or an audio signal. The hybrid multimedia stream 80 may also include other types of elementary data streams such as, for example, data stream 68. Thus, while FIG. 4 depicts all four of video stream 64, audio stream 66, data stream 68, and formatted multimedia compression data stream 76, other embodiments of a hybrid data stream 80 may only contain formatted multimedia compression data stream 76 and any one of video stream 64 and/or audio stream 66, for example.

Exemplary hybrid multimedia stream 80 is comprised of a plurality of alternating audio data blocks 82, video data blocks 84, private data blocks 86, and multimedia compression data blocks 88. Audio data blocks 82 represent data from audio stream 66, and video data blocks 84 represent data from video stream 64. Likewise, private data block 86 represents data incorporated from private data stream 68 while multimedia compression data block 88 represents data originating from formatted multimedia compression data stream 76.

Audio data blocks 82, video data blocks 84, private data blocks 86, and multimedia compression data blocks 88 may be encoded in any format and is only limited by the particular standard employed (e.g. MPEG-2, MPEG-4, etc.). For example, the blocks may be in any sequence and each block may vary in size. Accordingly, for example, private data blocks 86 or multimedia compression data blocks 88 may be placed at the beginning, at the end, or intermittently throughout the hybrid multimedia stream 80.

FIG. 4 also depicts an exploded view of an exemplary multimedia compression data block 88 which may be embedded within the hybrid multimedia stream 80. Multimedia compression data block 88 may include fields, such as, but not limited to, a Header Field 90, a Tag ID field 92, a Length Field 94, and a Data Field 96. Multimedia compression data block 88 may be further encapsulated within a transport packet of a particular multimedia format. For example, multimedia compression data block 88 may be encapsulated within a packetized elementary stream (PES) packet, as defined by the MPEG-2 standard.

Header field 90 may include subfields useful for decoding and extracting the information from multimedia compression data block 88. Subfields may include, but are not limited to, the Special ID Subfield 98, Version Subfield 100, Length of the Data Subfield 102, Address of Tag ID Subfield 104, Address of Length Subfield 106, and Address of Data Subfield 108. The information in Header Field 90 may vary by application and the fields described herein are merely examples of one possible format.

The Special ID Subfield 98 may refer to identifying information that a decoder may use to identify multimedia compression data block 88 as a block containing multimedia compression data, rather than other types of data which may be stored within a particular data stream. Version Subfield 100 may include information which a decoder could use to determine the format version of the data encapsulated in multimedia compression data block 88. The Length of the Data Subfield 102 indicates the total length of Data Field 96. For example, the Length of Data Subfield 102 may indicate that Data Field 96 has a total length of 1024 bytes. The Address of Tag ID Subfield 104 indicates the position in data block 88 where the Tag ID field 92 is located. The Address of Data Length Subfield 106 indicates the position in the data block 88 where the Length Field 94 is located. The Address of Data Subfield 108 indicates the position in the data block where the Data Field 96 is located. For example, each of the Address of Tag ID Subfield 104, Address of Data Length Subfield 106, and the Address of Data Subfield 108 may contain a hexadecimal number referencing a specific memory location, or an offset from a predetermined memory location.

Tag ID Field 92 may identify an identifying tag for the multimedia compression information data. For example, an identifier corresponding to a starting and ending position in the multimedia stream indicating the location of a commercial may be stored under the appropriate tags. Accordingly, Tag ID Field 92 may contain data identifying a “starting position 1” as equivalent to “tag 1,” “ending position 1” as equivalent to “tag 2,” and “starting position 2” as equivalent to “tag 3,” and “ending position 2” as equivalent to “tag 4.” The multimedia compression identifiers and their tags are not limited to those described above and will vary depending on the type of multimedia compression information to be embedded. Furthermore, the identifiers and tags are not limited to any particular order. The identifiers and their identifying tags may, for example, be any series of numbers or letters that can be decoded to identify the multimedia compression information in Data Field 96.

Data Field 96 may contain the actual multimedia compression data and the associated tag for each tag defined in the “Tag ID” field. For example, in the exemplary embodiment, the starting position of commercial content corresponding to “starting position 1” may be found by searching sequentially, or otherwise, for the associated “tag 1” within the Data Field 96.

In one embodiment, to assist in searching for a particular tag and its associated data within Data Field 96, multimedia compression data block 88 may also include a Length of Data Field 94 which contains the length (e.g. the number of bits) of the multimedia compression information data associated with a particular tag within Data Field 96.

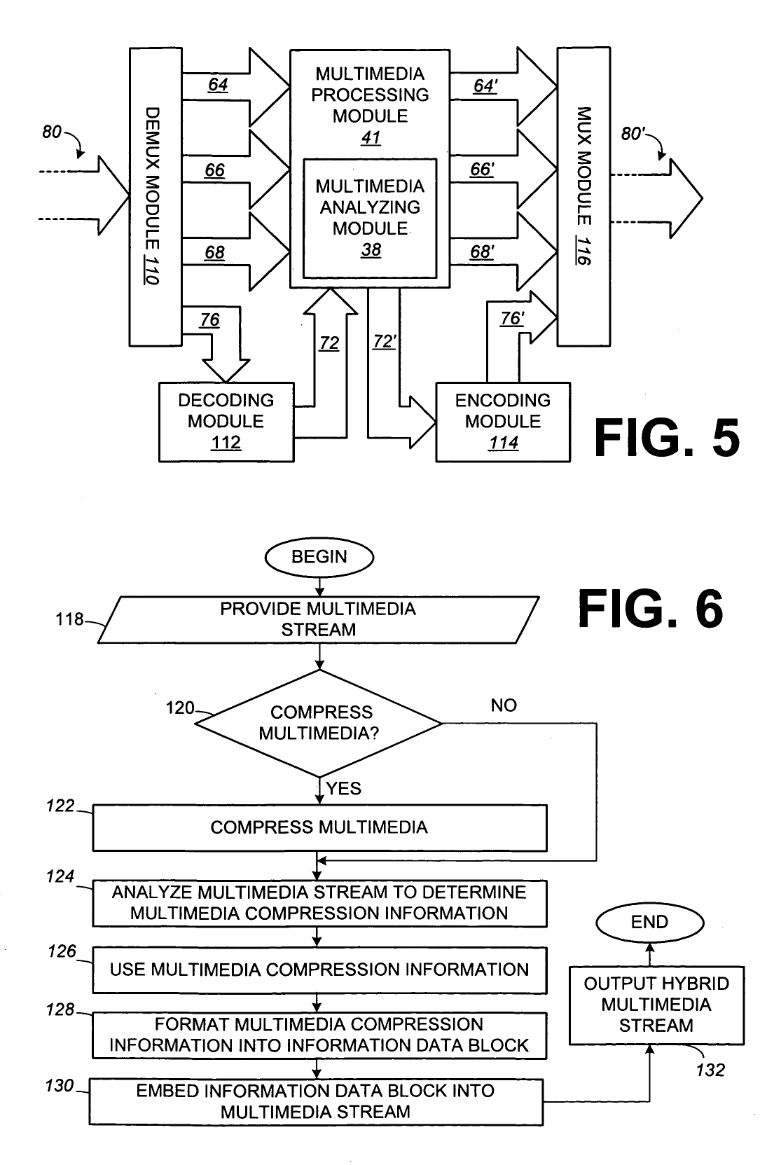

Referring to FIG. 5, another embodiment of a system for embedding multimedia compression information in, and extracting multimedia compression information from, a multimedia bitstream is depicted. The illustrated embodiment includes a demultiplexer, here in DEMUX 110 for demultiplexing, or separating, multimedia streams into elementary streams, a multimedia processing module 41, a multimedia analyzing module 38 for determining multimedia compression information, a decoding module 112 for converting data from a particular multimedia standard (e.g. MPEG-2, etc.) into a format recognizable to multimedia processing module 41, an encoding module 114 for converting data into a bitstream compliant to a particular multimedia standard, and a MUX 116 for multiplexing, or combining, each of the video stream 64′, audio stream 66′, private data stream 68′, and formatted multimedia compression data stream 76′ into hybrid multimedia stream 80′.

Multimedia analyzing module 38 is configured to operate substantially as described in relation to FIG. 3. In some embodiments, as in the embodiment of FIG. 5, multimedia analyzing module 38 may be integrated within other executable modules. For example, in FIG. 5, multimedia analyzing module 38 is integrated within multimedia processing module 41.

In general, multimedia processing module 41 performs multimedia processing tasks such as compressing, filtering, or adjusting the color of video in a multimedia bitstream. Processing module 41 may, in part, manipulate the multimedia file based on multimedia compression information.

Accordingly, a user may wish to manipulate the multimedia bitstream by compressing the video and/or audio content of the multimedia bitstream. For example, multimedia processing module 41 may use multimedia compression information indicating the position of commercials in the video, or other audio and/or video characteristics, to assist in compressing the multimedia bitstream. For example, because increased compression may decrease the playback quality of video and audio content, it may be preferable to compress positions of the multimedia bitstream corresponding to commercial content more than portions corresponding to non-commercial content. Similarly, because many compression algorithms compress portions of video having less motion or complexity with better playback quality, multimedia processing module 41 may be configured to compress portions of video having less motion or complexity more than portions of video having more motion or complexity.

Because it is desirable to complete multimedia compression tasks in as little time as possible, it is preferable not to wait an extended time for multimedia analyzing module 38 to analyze the multimedia bitstream to determine the multimedia compression information. Additionally, once the multimedia compression information has been determined, it is preferable not to reanalyze the multimedia bitstream if this information is needed again. Accordingly, multimedia compression information may be embedded in the multimedia bitstream, and subsequently extracted by multimedia processing module 41 (or other executable modules), such that complex analysis is not required, or is substantially reduced.

In addition to multimedia processing module 41, other executable modules such as, but not limited to, multimedia playback module 39 and multimedia editing module 40 may also use multimedia compression information to manipulate a multimedia bitstream. These modules may also be configured to embed multimedia compression information in, and/or extract multimedia compression information from, a multimedia bitstream.

For example, multimedia editing module 40 performs multimedia editing tasks which may, in part, be based on the multimedia compression information embedded in the multimedia bitstream. As explained above, one example of information that may be used for multimedia compression is the position of commercial content in the video. Accordingly, during the process of editing video content, a user may command the multimedia editing module to automatically detect the commercial content in the multimedia content to assist in organizing the movie for editing. For example, multimedia editing module 40 may be configured to remove portions of the multimedia content corresponding to commercials or replace commercial content with other audio and/or video content. The multimedia editing module may split the multimedia bitstream into separate bitstreams defined by the commercial positions. Because the commercial positions may already be embedded within the multimedia bitstream, and this information may be extracted and used for the editing process, it may not be required to re-analyze the multimedia bitstream for this task.

Thus, multimedia editing module 40 may, among other multimedia editing-tasks, be configured to read in a multimedia compression information determined from multimedia analyzing module 38 and perform multimedia editing tasks based on this multimedia compression information.

As an additional example, multimedia playback module 39 may be used to play the video and/or audio content of a multimedia bitstream. Multimedia playback module 39 may use multimedia compression information extracted from the multimedia bitstream to manipulate the playback of the multimedia bitstream. For example, a playback module 39 may be configured to use the positions of scene changes, included in the multimedia compression information, to provide automatic chapters or skip-points.

Executable modules, such as multimedia playback module 39, multimedia editing module 40, and multimedia processing module 41, may also be configured to embed information obtained from analyzing the multimedia bitstream and/or information related to the editing or processing performed on the video and/or audio content. For example, multimedia processing module 41 may perform processing steps such as, but not limited to, compressing the multimedia bitstream, normalizing the volume of an audio bitstream, changing the contrast or brightness level of a video bitstream, changing the color saturation of a video bitstream, speeding up or slowing down the playback of the bitstream, enhancing video content, or blurring the video content. When performing processing tasks, multimedia processing module 41, or other executable modules, may perform analysis on the multimedia bitstream. The results of the multimedia processing analysis may be useful for multimedia compression in later analysis. For example, to determine the position of commercial content in a multimedia bitstream, motion analysis may be performed on the multimedia bitstream. The results of the motion analysis may also be embedded in the bitstream. Accordingly, the results of the motion detection analysis may be later extracted by multimedia analyzing module 38 in an effort to reduce the repeated analysis of the multimedia bitstream when determining multimedia compression information in a later analysis.

While FIG. 5 depicts DEMUX 110, MUX 116, decoding module 112, and encoding module 114 as separate modules, it should be understood that each of these modules may be incorporated within multimedia processing module 41. Additionally, as in the embodiments of FIGS. 3 and 4, multimedia stream 80 may be in a variety of multimedia formats and may undergo a variety of pre-processing steps which are not shown. For example, the multimedia stream may be captured in a first format and converted into another format, which may also involve compression of the video and/or audio data.

In some embodiments, a demultiplexer, DEMUX 110, separates hybrid multimedia stream 80 into individual elementary streams such as video stream 64, audio stream 66, private data stream 68, and formatted multimedia compression data stream 76. Multimedia compression data stream 76, which may include a plurality of multimedia compression data blocks 88, is passed through decoding module 112. Decoding module 112 is configured to decode the data stored within the multimedia compression data blocks 88, format the data, and pass the data to multimedia processing module 41, which may use the multimedia compression information within the data to process the audio or video within video stream 64 and/or audio stream 66.

Multimedia processing module 41 may request and receive the multimedia compression information from multimedia analyzing module 38. In some embodiments, however, multimedia processing module 41 may be configured to directly check the multimedia bitstream for multimedia compression information which may have been embedded therein.

If multimedia compression information is not embedded within the multimedia bitstream, if the multimedia compression information needs to be updated, or if different multimedia compression information is needed by multimedia processing module 41, then multimedia analyzing module 38 may be configured to provide the appropriate multimedia compression information as described in the embodiments of FIG. 3.

Once the multimedia compression information is provided by multimedia analyzing module 38, or otherwise extracted from the multimedia bitstream, multimedia processing module 41 may then compress the multimedia content based on the multimedia compression information.

In the embodiment of FIG. 5, multimedia stream 80 is in the same format of multimedia stream 80 as output from MUX 78 from FIG. 4. Thus, exemplary multimedia stream 80 includes a plurality of alternating audio data blocks 82, video data blocks 84, private data blocks 86, as well as multimedia compression data blocks 88.

In practice, an executable module is used to decode multimedia compression data blocks 88 within formatted multimedia compression data stream 76. For example, decoding module 112 may read the Special ID Field 98 in Header Field 90 to determine whether the particular data block is, in fact, one containing multimedia compression information. If so, decoding module 112 looks to the Version Subfield 100 to determine whether the version of the multimedia compression data block 88 is known, and therefore able to decode the multimedia data stored within Data Field 96. If decoding module 112 determines that the multimedia data can be decoded, decoding module 112 inspects the contents of Address of Tag ID Subfield 104, Address of Data Length 106, and the Address of Data Subfield 108 to determine the starting address of the Tag ID Field 92, Data Length Field 94 and Data Field 96, respectively.

Decoding module 112 may then jump to the starting address of the Tag ID Field 92, and parse each of the tags and their associated values within Tag ID Field 92, thereby determining the associated tags for the compression information. In some instances, decoding module 112 may only be interested in a subset of the total information stored in Data Field 96, such as the “starting position 1” and “ending position 1” information. In this example, the decoding module 112 may only parse the Tag ID Field 92 until the module determines that “tag 1” and “tag 2” correspond to the “starting position 1” and “ending position 1” information, respectively.

Decoding module 112 may then jump to the starting address of the Length of Data Field 94. Decoding module 112 may read the contents of the Length of Data Field 94 to determine the length of the multimedia compression information data associated with each tag for which it seeks information. In this example, decoding module 112 determines the length of the multimedia compression information data associated with “tag 1” and “tag 2.” For example, Length of Data Field 94 may contain data indicating that the data associated with “tag 1” has a length of 32 bytes, and the data associated with “tag 2” has a length of 64 bytes.

Decoding module 112 may then jump to the start of Data Field 96 and parse through the data contained therein until it finds either “tag 1” or “tag 2,” which may indicate the start of the associated multimedia compression information.

Beginning with the tag and reading to an offset address determined from the length of compression information associated with the tag, decoding module 112 may read and temporarily store the associated multimedia compression information in memory. The executable module then continues parsing the Data Field 96 until finding the remainder of the tags by repeating the step of reading the multimedia compression information associated with each tag.

The resulting decoded multimedia compression data 72 is output from decoder 112 in a predetermined format. The multimedia compression information in the multimedia compression data 72 may then be passed into multimedia processing module 41 for use in manipulating the multimedia bitstream.

Multimedia analyzing module 38 may perform analysis of the multimedia bitstream that may be useful for a variety of multimedia manipulation tasks. Thus, although this analysis provides information representing characteristics of the multimedia bitstream useful for compressing multimedia, the analysis may also be useful for other manipulation tasks. Accordingly, the information from the various analyses may also be saved and encoded back into multimedia stream 80 in a manner similar to that described in relation to FIGS. 3 and 4. This information useful for multimedia manipulation could be encoded into, for example, private data stream 68′ or multimedia compression data stream 76′, and embedded within hybrid multimedia stream 80′. The hybrid stream 80′ may then be decoded and used by any subsequent executable module configured to extract the multimedia manipulation information from multimedia stream 80′. For example, multimedia playback or editing modules may find this analysis useful for playing or editing the multimedia bitstream.

Once multimedia compression information is embedded within a multimedia stream, the amount of reanalyzing of audio and/or video content to determine the multimedia compression information may be lessened or eliminated. By embedding the multimedia compression information within the bitstream, rather than storing it in a separate file for example, the multimedia compression information is not separated from the bitstream. Thus, even if the multimedia bitstream is passed to another computer for further manipulation, the information is available for extraction. By embedding the multimedia compression information in the bitstream itself, the reanalysis of the multimedia bitstream in subsequent multimedia manipulation steps may be dramatically reduced. For example, rather than reanalyzing the multimedia bitstream, results of previous analyses may be extracted from the bitstream.

FIG. 6 represents an exemplary flow diagram depicting a method for embedding multimedia compression information into a multimedia stream. At step 118, a multimedia file is provided, for example, by a multimedia acquisition module. The multimedia bitstream may be provided by acquiring the bitstream from mass storage 48, remote server 24, memory 34, or optical disc 30 (FIG. 1), for example. It should be understood that the systems and methods for embedding multimedia compression information in, and extracting multimedia compression information from, a multimedia bitstream, do not require the step of providing the bitstream.

Because multimedia files, such as DV files, may be excessively large, it is sometimes beneficial to compress the multimedia bitstream. Thus, at decision block 120, a determination is made as to whether compression of the multimedia information is needed. If compression is needed (the YES condition), the multimedia information is compressed, and possibly converted to a new format, using techniques well known to those skilled in the art in step 122. For example, a DV file may be compressed and converted to MPEG-2, or a bitstream already in MPEG-2 format may be further compressed.

The compression step 122 performs an analysis of the multimedia bitstream that produces multimedia compression information. For example, analysis for multimedia compression may include performing motion estimation. In addition, if desired, analysis other than that needed for the multimedia compression may be performed during compression step 122. The resulting multimedia compression information from the analysis performed in compression step 122 (and/or information resulting from other analysis) may be embedded into the compressed multimedia stream.

Continuing with the flow diagram of FIG. 6, if compression is not performed (the NO condition), or after a bitstream has already been initially compressed in step 122, the multimedia content may be analyzed in step 124 to determine multimedia compression information.

In the case that the bitstream has already been compressed in step 122, there may be additional analysis on the newly compressed bitstream that may be performed should further compression of the multimedia bitstream be required. Additionally, it is possible that only an initial, non-complete, compression was performed in step 122 to save time.

At step 126 the multimedia compression information may be used to manipulate a multimedia bitstream by an executable module. For example, a multimedia processing, playback, or editing module may use multimedia compression information to manipulate the bitstream. At step 128, the multimedia compression information may be formatted into at least one data block. At step 130, the data representing the multimedia compression information is embedded into the multimedia stream, for example, by multiplexing the multimedia compression information with video, audio, and/or data. This stream of data is output in step 132 as a hybrid data stream containing both multimedia compression information and multimedia content, such as video and/or audio data.

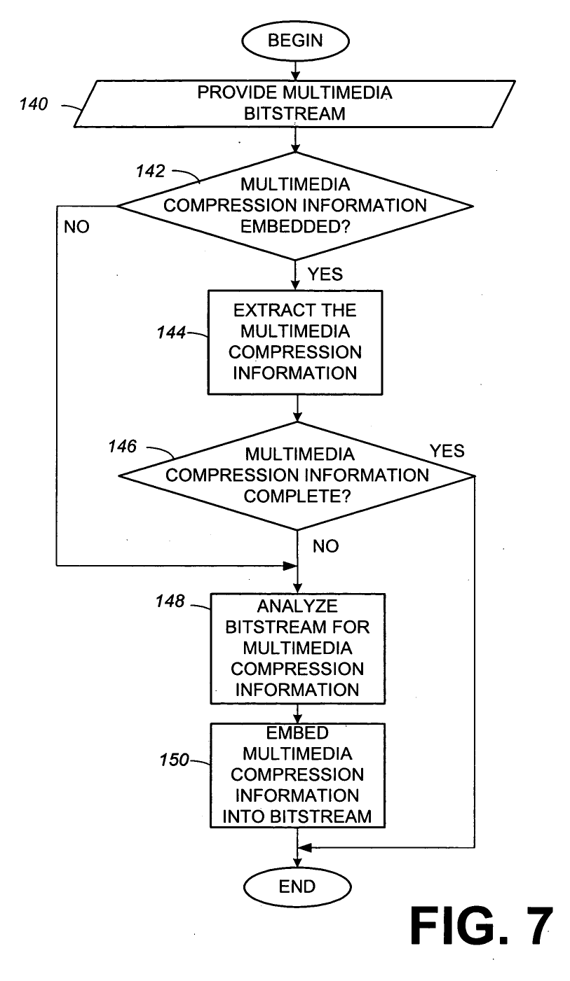

FIG. 7 depicts an exemplary flow diagram representing how a system employing multimedia processing module 41, or other executable modules, might use a hybrid multimedia stream having multimedia compression information embedded therein. At step 140, a multimedia stream is provided which may, or may not, be a hybrid multimedia stream containing multimedia compression information. The multimedia bitstream may be provided by acquiring the bitstream from mass storage 48, remote server 24, memory 34, or optical disc 30 (FIG. 1), for example. It should be understood that the systems and methods for embedding multimedia compression information in, and extracting multimedia compression information from, a multimedia bitstream, do not require the step of providing the bitstream.

At decision block 142, a determination is made as to whether any multimedia compression information is already embedded within the provided multimedia stream. This step may also include decompressing, decoding, and/or demultiplexing the multimedia stream.

On the condition that at least some multimedia compression information is embedded in the multimedia stream (the YES condition of decision block 142), the multimedia compression information is extracted in step 144 and a determination is made at decision block 146 whether the embedded multimedia compression information represents all the multimedia compression information that is needed by the multimedia processing module. This determination may be accomplished by merely analyzing the header information of the multimedia data blocks within the hybrid multimedia stream, or by analyzing the multimedia compression information itself.

If all the multimedia compression information that is needed for the multimedia processing module is embedded within the data stream (the YES condition of decision block 146), then the multimedia processing module may then extract and receive the multimedia compression information and use it to manipulate the multimedia bitstream. For example, multimedia processing module may, for example, compress the multimedia bitstream using the multimedia compression information.

However, if the necessary multimedia compression information for the executable module is not embedded in the hybrid stream (the NO condition of block 146), the multimedia stream may be analyzed in step 148 to determine and acquire the additional multimedia compression information. For example, in some cases, a multimedia compression information in the multimedia bitstream may pertain to only a portion of the subject multimedia bitstream. Accordingly, some additional analysis of the portions not previously analyzed for multimedia compression information may need to be completed. The multimedia processing module may be configured to use both the multimedia compression information extracted from the hybrid stream and the multimedia compression information discovered from analyzing the multimedia stream in step 148 to manipulate the audio and/or video content.

In contrast to situations in which there is no useful multimedia compression information embedded in the multimedia stream, only the missing information may need to be determined in step 148. Therefore, step 148, which analyzes the multimedia content for multimedia processing information, is potentially less complicated and time consuming than if a full analysis, including all previously performed analysis, is performed.

If decision block 142 indicates that no multimedia compression information is embedded in the multimedia bitstream (the NO condition), the multimedia analyzing module analyzes the multimedia bitstream to determine the multimedia compression information. The multimedia processing module, or other executable modules, may then use the multimedia compression information for manipulating the multimedia content. At step 150, the multimedia compression information, and any information related to the multimedia bitstream analysis performed to detect the multimedia compression information, may be embedded into the multimedia bitstream. In addition to embedding multimedia compression information, if the multimedia bitstream was modified, by other editing or processing steps, for example, information related to how the multimedia bitstream was modified may be embedded into the multimedia bitstream.

Once the multimedia compression information is embedded within the multimedia stream, the information may be extracted and used by any executable module, such as, but not limited to, a multimedia playback module, multimedia processing module, or multimedia editing module configured to extract the information from the multimedia data stream.

Embodiments have been described which embed multimedia compression information into the multimedia bitstream by multiplexing a separate, user-defined data stream with multimedia bitstreams. However, some embodiments may embed the multimedia compression information in other ways, and the format of the hybrid stream, or the process used to embed the multimedia compression information to create the hybrid stream, is not limited to any one embodiment.

For example, in some embodiments, multimedia compression information may be directly embedded in the same bitstream as the video and/or audio information. For example, some multimedia formats, such as formats following the MPEG standard, incorporate user defined data, also known as user data, within the video and/or audio bitstreams. User data may contain any binary data and is not necessarily associated with the video or audio information. Accordingly, this user data may, at least in part, correspond to multimedia compression information. This user data, corresponding to multimedia compression information, may be embedded into the bitstream as defined by the particular multimedia format. Similarly, the multimedia compression information may be extracted and used for subsequent multimedia processing, editing, or analyzing.

Additionally, in some embodiments, multimedia compression information may be embedded within multimedia streams that do not specifically allow for embedding user defined data within the multimedia stream. For example, it is possible to add a pattern of bits to a multimedia bitstream without altering the perceivable audio and/or video content. These bits may contain any binary data and are not necessarily associated with the video or audio information. For example, these techniques are used when embedding digital watermarks to identify copyright information in multimedia bitstreams. Accordingly, similar techniques may be used to embed multimedia compression information within these multimedia streams. Just as digital watermarks, for example, can be detected within a bitstream, similar techniques may be used to extract multimedia compression information from the multimedia bitstream. This multimedia compression information may then be used for manipulating the multimedia bitstream by processing or editing, for example.

Accordingly, the above embodiments are merely examples of the many possible ways to embed multimedia compression information within a multimedia bitstream. Similarly, the above embodiments include mere examples of how to extract and use multimedia compression information embedded within a hybrid bitstream. Additionally, it should be emphasized that many variations and modifications may be made to the above-described embodiments. All such modifications and variations are intended to be included herein within the scope of this disclosure and protected by the following claims.

What is claimed is:

1. A method for processing a multimedia bitstream comprising:
analyzing a multimedia bitstream for characteristics of a multimedia signal useful for compressing the multimedia content within the multimedia bitstream;
generating multimedia compression information based on the characteristics of the multimedia signal useful for compressing the multimedia content; and
embedding the multimedia compression information into the multimedia bitstream to produce a hybrid multimedia data stream.

2. The method of claim 1, further including:
providing the multimedia bitstream.

3. The method of claim 1, further including:
extracting the multimedia compression information from the multimedia bitstream; and
manipulating the multimedia bitstream based on the extracted multimedia compression information.

4. The method of claim 3, wherein the step of manipulating is performed by:
compressing the multimedia bitstream based on the extracted multimedia compression information.

5. A method for processing a multimedia bitstream comprising:
embedding multimedia compression information within a multimedia bitstream, the multimedia compression information signifying characteristics of a multimedia signal useful for compressing multimedia content within the multimedia bitstream.

6. The method of claim 5, further including:
providing a multimedia bitstream.

7. The method of claim 5, further including:
determining the multimedia compression information using at least one of the following steps:
analyzing the multimedia bitstream to determine characteristics of the multimedia signal;
extracting the multimedia compression information from the bitstream; and
receiving the multimedia compression information.

8. The method of claim 7, further including:
formatting the multimedia compression information into at least one information data block;
wherein the step of embedding the multimedia compression information further includes embedding the at least one information data block into a plurality of multimedia data blocks to produce a hybrid multimedia data stream.

9. The method of claim 5, wherein the step of embedding the multimedia compression information includes at least one of the following:
embedding an indicator of the motion type associated with at least one segment of the video signal;
embedding an indicator of the motion range associated with at least one segment of the video signal;
embedding an indicator of the motion velocity associated with at least one segment of the video signal;
embedding an indicator of spatial or temporal complexity of at least one segment of video;
embedding an indicator of spatial or temporal importance of at least one segment of video;
embedding an indicator of a facial area associated with at least one segment of the video signal;
embedding information representing a scene change start position and a scene change end position in the multimedia signal;
embedding information representing the spatial location or the temporal duration of at least one facial region in the video; and
embedding information representing a commercial start position and a commercial end position in the multimedia signal.

10. The method of claim 5, further including the step of determining the multimedia compression information based on the characteristics of the multimedia signal, the multimedia signal including a video signal;
wherein the step of determining the multimedia compression information based on the characteristics of the multimedia signal comprises at least one of the following:
determining the motion type of at least one segment of the video;
determining the motion range of at least one segment of the video;
determining the motion velocity of at least one segment of the video;
determining spatial or temporal complexity of at least one segment of the video;
determining whether at least one segment of the video includes a facial area;
determining spatial or temporal importance of at least one segment of the video;
determining the location of commercial content in the video;
determining the spatial location or temporal duration of facial regions in the video; and
determining the location of scene change information in the video.

11. The method of claim 5, further including:
extracting the multimedia compression information from the multimedia bitstream; and
manipulating the multimedia bitstream based on the extracted multimedia compression information.

12. The method of claim 1 1, wherein the step of manipulating is performed by:
compressing the multimedia bitstream based on the extracted multimedia compression information.

13. The method of claim 5, wherein the step of embedding the multimedia compression information within the multimedia bitstream includes any one of the following:
multiplexing bits representing the multimedia compression information with the content representing the multimedia signal;
embedding bits representing the multimedia compression information directly into the multimedia bitstream; or
embedding a pattern of bits representing the multimedia compression information into the multimedia bitstream without altering the perceivable multimedia content.

14. The method of claim 5, further including:
extracting information determined from a prior analysis of the multimedia bitstream from the multimedia bitstream; and
analyzing the extracted information to determine the multimedia compression information.

15. The method of claim 5, further including:
detecting if the multimedia bitstream contains embedded multimedia compression information.

16. The method of claim 15, further including:
identifying the multimedia compression information in the multimedia bitstream; and
determining if additional multimedia compression information is necessary to manipulate the multimedia bitstream, and wherein upon determining the additional multimedia compression information is necessary to manipulate the multimedia bitstream, acquiring the additional multimedia compression information.

17. The method of claim 16, wherein upon acquiring the additional multimedia compression information, embedding the additional multimedia compression information into the multimedia bitstream.

18. The method of claim 15, further including:
identifying the embedded multimedia compression information in the multimedia bitstream; and
determining if additional multimedia compression information is necessary to manipulate the multimedia bitstream;
wherein upon determining that the additional multimedia compression information is not necessary to manipulate the multimedia bitstream, extracting the embedded multimedia compression information.

19. The method of claim 15, wherein upon detecting that the multimedia bitstream does not contain the embedded multimedia compression information, determining the multimedia compression information;
wherein the step of embedding the multimedia compression information includes embedding the multimedia compression information resulting from determining the multimedia compression information.

20. The method of claim 15, wherein upon detecting that the multimedia bitstream does contain the embedded multimedia compression information, extracting the embedded multimedia compression information from the multimedia bitstream.

21. A computer readable medium having a computer program for processing a multimedia bitstream comprising:
a code segment for embedding multimedia compression information within a multimedia bitstream, the multimedia compression information signifying characteristics of a multimedia signal useful for compressing multimedia content within the multimedia bitstream.

22. The computer readable medium of claim 21, further including:
a code segment for providing the multimedia bitstream.

23. The computer readable medium of claim 21, further including:
a code segment for determining multimedia compression information; and
a code segment for formatting the multimedia compression information into at least one information data block;
wherein the code segment for embedding the multimedia compression information further includes embedding the at least one information data block into a plurality of multimedia data blocks to produce a hybrid multimedia data stream.

24. The computer readable medium of claim 21, further including:
a code segment for extracting the multimedia compression information from the multimedia bitstream; and
a code segment for manipulating the multimedia bitstream based on the extracted multimedia compression information.

25. The computer readable medium of claim 21, further including:
a code segment for detecting if the multimedia bitstream contains embedded multimedia compression information.

26. The computer readable medium of claim 25, further including:
a code segment for extracting the embedded multimedia compression information from the multimedia bitstream upon the code segment for detecting if the multimedia bitstream contains embedded multimedia compression information detecting that the multimedia bitstream contains the embedded multimedia compression information.

27. A system for processing a multimedia bitstream comprising:
an executable module for embedding multimedia compression information within a multimedia bitstream, the multimedia compression information signifying characteristics of a multimedia signal useful for compressing multimedia content within the multimedia bitstream.

28. The system of claim 27, wherein the system further includes:
an executable module for determining the multimedia compression information, wherein the executable module determines the multimedia compression information by any one of the following:
analyzing the multimedia bitstream to determine characteristics of the multimedia signal;
extracting the multimedia compression information from the multimedia bitstream; and
receiving the multimedia compression information from a user.

29. The system of claim 27, further including:
an executable module for extracting the multimedia compression information from the multimedia bitstream; and
an executable module configured to use the extracted multimedia compression information to manipulate the multimedia bitstream.

30. The system of claim 27, further including:
a demultiplexer for separating a data stream having the multimedia compression information from a hybrid multimedia bitstream.

31. The system of claim 27, further including:
a multiplexer for combining a data stream having the multimedia compression information with the multimedia bitstream to form a hybrid multimedia bitstream.

32. A system for processing a multimedia bitstream comprising:
an executable module configured to extract multimedia compression information from a multimedia bitstream, the multimedia bitstream having multimedia content representing a multimedia signal and the multimedia compression information embedded-therein.

33. The system of claim 32, further including:
an executable module configured to provide a multimedia bitstream to the executable module configured to extract multimedia compression information.

34. The system of claim 32, further including:
an executable module for determining additional multimedia compression information, wherein the executable module determines the additional multimedia compression information by any one of the following:
analyzing the multimedia bitstream to determine characteristics of the multimedia signal; and
receiving the multimedia compression information.

35. The system of claim 34, further including:
an executable module configured to embed the extracted multimedia compression information and the additional multimedia compression information within the multimedia bitstream.

36. The system of claim 32, further including:
a multimedia manipulation module configured to manipulate multimedia content within the multimedia bitstream using the multimedia compression information.

37. A system for processing a multimedia bitstream comprising:
an executable module for extracting information determined from a prior analysis of the multimedia bitstream from the multimedia bitstream;
an executable module for determining multimedia compression information by using the extracted information from the prior analysis; and
an executable module for embedding the multimedia compression information in the multimedia bitstream.
